(19) United States
(12) Patent Application Publication
(10) Pub. No.: US 2026/0074649 A1
(43) Pub. Date: Mar. 12, 2026

(54) STORM HARDENED SOLAR RACKING SYSTEM

(71) Applicants: James F. Loven, Scranton, PA (US); Robert J. Loven, Scranton, PA (US)

(72) Inventors: James F. Loven, Scranton, PA (US); Robert J. Loven, Scranton, PA (US)

(21) Appl. No.: 19/305,945

(22) Filed: Aug. 21, 2025

Related U.S. Application Data
(63) Continuation of application No. PCT/US24/16700, filed on Feb. 21, 2024.
(60) Provisional application No. 63/447,307, filed on Feb. 21, 2023.

(51) Int. Cl. H02S 30/10; F16F 15/02; F24S 30/00; F24S 30/425

(52) U.S. Cl. CPC H02S 30/10; F16F 15/02; F24S 30/425; F24S 2030/115; F24S 2030/15; F24S 2030/19

(57) ABSTRACT

A solar racking system for mitigating deformation and fatigue at critical joints and for providing increased clamping force between solar racking and solar panels is disclosed. The solar racking system includes one or more shock mount systems configured to reduce vibrations within the solar racking system, thereby preventing hole elongation and in turn, allowing the solar racking system to withstand critical wind events and other harsh weather conditions. Moreover, the solar racking system includes a dual clamp system having angled clamping plates and planar clamping plates configured to couple solar panels to racking of the solar system that provide increased clamping force, thereby providing maximum strength and vibration resistance.

### CROSS-REFERENCE TO RELATED APPLICATIONS

The disclosure claims the benefit to International Application No. PCT/US2024/016700 filed on Feb. 21, 2024 and U.S. patent application No. 63/447,307, filed Feb. 21, 2023, the disclosures of which are hereby incorporated by reference in their entirety.

### BACKGROUND

Solar racking systems are used to mount solar panels to a variety of surfaces, such as ground surfaces, roofs, or other structures. However, conventional solar racking systems have a low survivability rate when subjected to severe weather events. For example, wind gusts may shake the structure of the solar racking and panels causing severe vibrations in the solar racking system. As a result of the vibrations, the holes in which fasteners pass through to secure the frame become rounded out and the diameter of the holes increase (i.e., an effect known as hole elongation). As the holes increase in diameter, the fasteners loosen causing the vibrations of the solar racking system to increase when subjected to additional weather events. Moreover, conventional clamping systems may rely on a single bolt clamp to secure a portion of a solar panel to the frame of the solar racking. However, as the vibrations on the system increase, the single bolt clamps tend to loosen. In turn, the vibrations cause the single bolt clamps to unfasten one-by-one resulting in the solar panels becoming separated from the solar racking. As such, conventional solar racking systems may essentially be considered self-destructive systems. Thus, it is not a question of “if” a conventional solar racking system will fail, but rather, “when” the solar racking system will fail.

### SUMMARY

The present disclosure relates generally to solar racking systems, and more particularly, to shock mount and dual clamp systems that mitigate damage to the solar racking systems caused by severe weather. For example, the shock mount system may be configured reduce vibrations within the solar racking system, thereby preventing hole elongation and in turn, allowing the solar racking system to withstand critical wind events and other harsh weather conditions.

Moreover, the dual clamp system may provide increased clamping force (e.g., twice the clamping force as conventional single bolt clamps) to couple a solar panel to racking of the solar racking system, thereby providing maximum strength and vibration resistance.

### BRIEF DESCRIPTION OF THE DRAWINGS

FIG. 1 illustrates an example solar racking system.

FIG. 2 illustrates example racking of the example solar racking system of FIG. 1.

FIG. 3A is an example beam coupled with an example shock mount system. FIG. 3B is an exploded view of the example shock mount system of FIG. 3A.

FIG. 4 is an exploded view of an example bearing rail and shock mount system.

FIG. 5A is a perspective top view of example shock mount systems coupled with the example racking of FIG. 2.

FIG. 5B is a perspective top view of other example shock mount systems coupled with the example racking of FIG. 2.

FIG. 6 illustrates an example actuator integrated with the example racking of FIG. 2.

FIG. 7 illustrates an example end dual clamp.

FIG. 8 illustrates an example mid-dual clamp.

FIG. 9A illustrates an example installation process in which solar panels are mounted to example racking via example dual clamps of FIGS. 7 and 8.

FIG. 9B is a perspective view of the example end dual clamp of FIG. 7 coupled to a solar panel and the example racking.

FIG. 9C is a perspective view of the example mid-dual clamp of FIG. 8 coupled to a solar panel and the example racking.

FIG. 9D is a perspective view of the example mid-dual clamp of FIG. 8 coupled to two solar panels and the example racking.

FIG. 10 illustrates a series of racking sections.

### DETAILED DESCRIPTION

The following discussion omits or only briefly describes conventional features of solar racking systems, which are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “comprises” and/or “comprising,” when used in this specification, specify the presence of stated features, elements, and/or components, but do not preclude the presence or addition of one or more other features, steps, operations, elements, components, and/or groups thereof. Further, it is noted that, as used in the specification and the appended claims, the terms and/or phrases “coupled to”, “fastened”, “joined”, “mounted”, “secured”, “rotatably coupled”, and the like refer to the attachment of the referred to components to one another in a fixed manner and/or rotatably fixed manner. For instance, the attachment of the referred to components may be performed, for example, but not limited to, via mechanical fastening (e.g., bolting, riveting, and the like), bonding methods (e.g., gluing, welding, brazing, soldering, and the like), and other like methods. It is noted that the examples described herein may generally discuss mechanically fastening components together via thru bolts, spacers, and nuts.

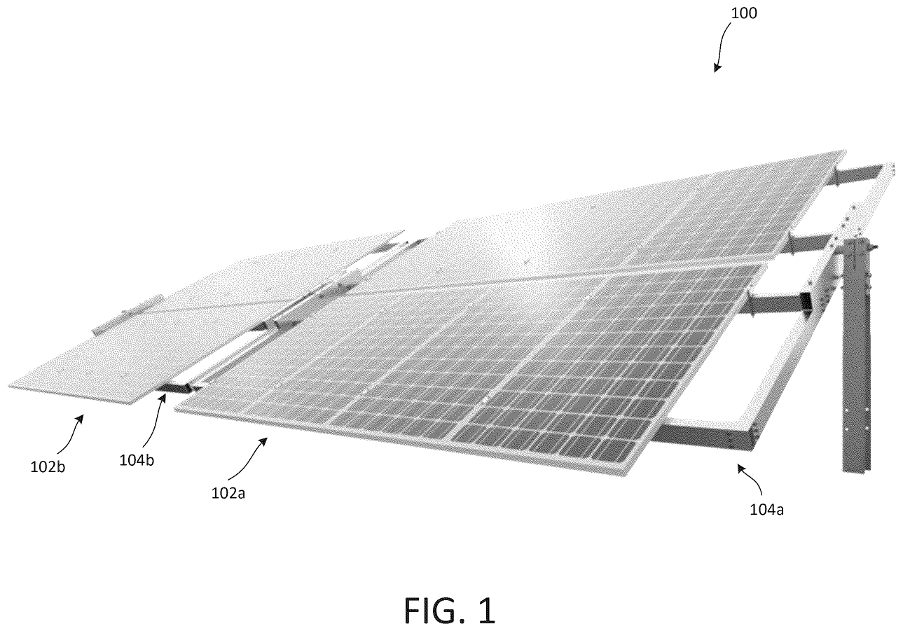

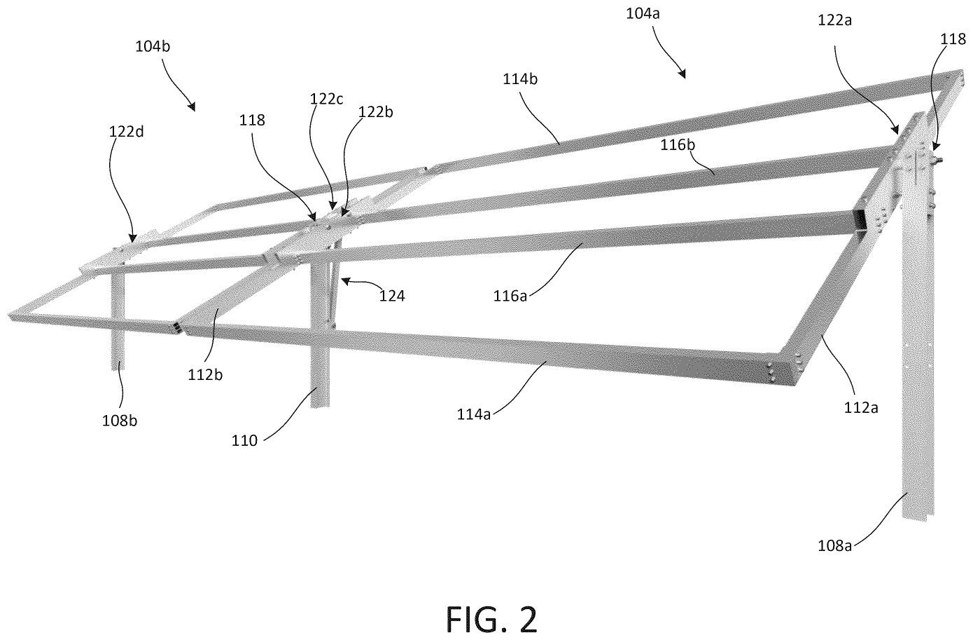

FIG. 1 illustrates an example solar racking system 100 (hereinafter “system 100”). FIG. 2 illustrates example racking components of the system 100. The solar racking system 100 may include racking and a support structure coupled to a photovoltaic (PV) array of solar panels. For example, the solar racking system 100 includes racking 104a coupled to support structures, such as beams 108a and 110, in which an array of solar panels, such as solar panel array 102a, may be mounted to the racking, as described herein.

The solar panel array, such as array 102a, may include a number of PV solar panels arranged in a pattern. For example, the pattern of PV solar panels of array 102a may be arranged in a 2 panel by 4 panel pattern and mounted on the racking 104a.

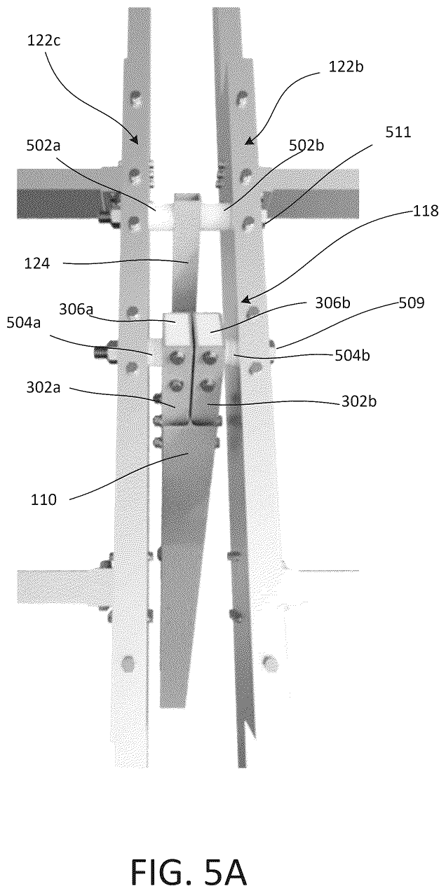

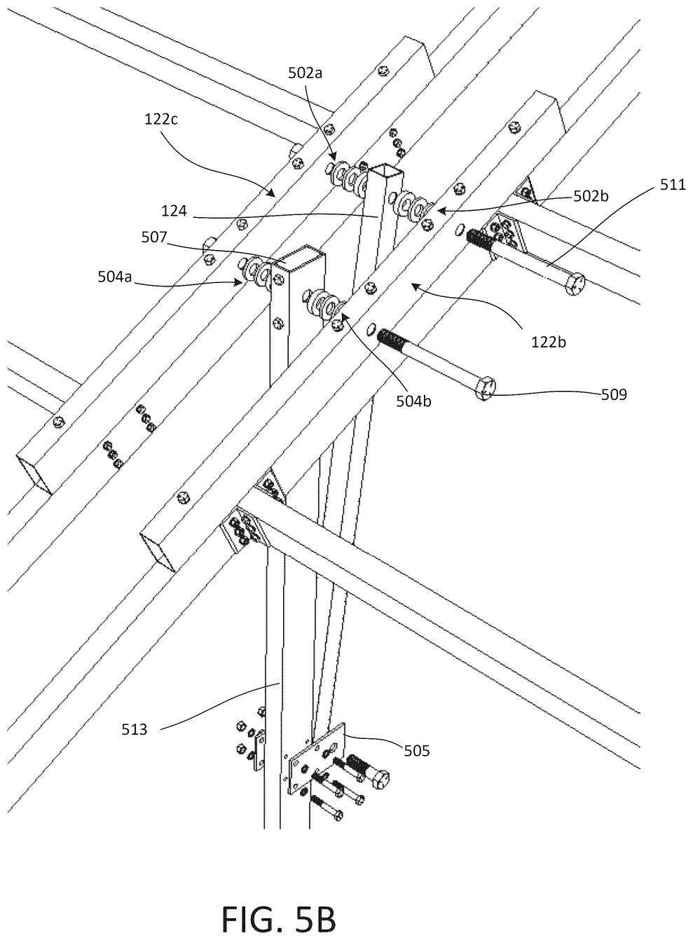

In one or more cases, the support structures, such as beams 108a, 108b, and 110, may be elongated beams. For example, the beams 108a, 108b, and 110 may be I-beams formed of, for example, but not limited to, galvanized steel. In one or more other cases, the support structures, such as beam 513 as illustrated in FIG. 5B, may be a pole or pile. For example, beam 513 may be a steel closed-form rectangular pile. It is noted that the type of support structure to be used as the foundation of the system 100 may be determined based on site design. For example, the type of support structure to be used as the foundation of the system 100 may be based on one or more of wind conditions at the location of the system 100 installation, soil density, elevation, and the like. In one or more cases, at least one support structure may be coupled to opposing sides of the racking. For example, beams 108a and 110 may be disposed on and coupled to opposite sides of racking 104a.

In one or more cases, the racking, such as racking 104a, may include main rails 114a and 114b that are respectively coupled to side rail assemblies 122a and 122b. In one or more cases, the racking 104 includes one or more mid-rails, such as mid-rails 116a and 116b, coupled to side rail assemblies 122a and 122b. The mid-rails may be disposed between main rails 114a and 114b. It is noted that the number of mid-rails included in the racking is based on the number of PV solar panels included for system 100. For example, as the PV solar panels of array 102a are arranged in a 2 panel by 4 panel pattern, racking 104a may include two mid-rails, such as mid-rails 116a and 116b. Further, it is noted that in some cases, the racking may not include mid-rails. In one or more cases, the rails of the racking, such as main rails 114a, 114b, side rail assemblies 122a and 122b, and mid-rails 116a and 116b may each be elongated rigid tubular members. For example, the rails may be formed in a closed-loop tubular shape. In some cases, the rails may be formed of a metal, such as aluminum, or a combination of metals.

The side rail assemblies of the racking may be bearing rails that are rotatably coupled to the respective proximal ends of the support structures, via a shock mount system, such as shock mount system 118. For example, side rail assembly 122b may be rotatably coupled to the beam 110 via shock mount system 118. In some cases, the shock mount system 118 may be coupled with one side rail assembly, such as side rail assembly 122a. In other cases, the shock mount system 118 may be coupled to two side rail assemblies, such as side rail assemblies 122b and 122c.

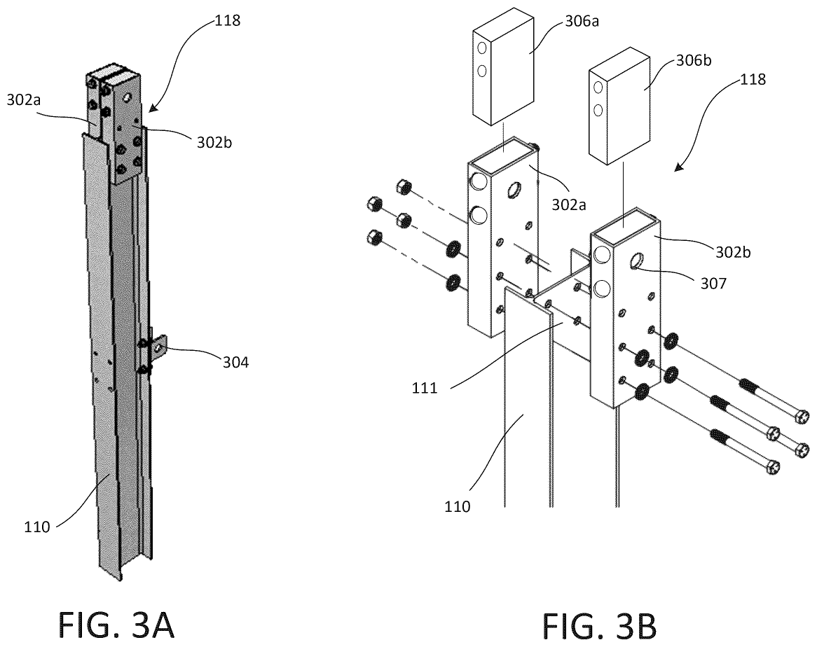

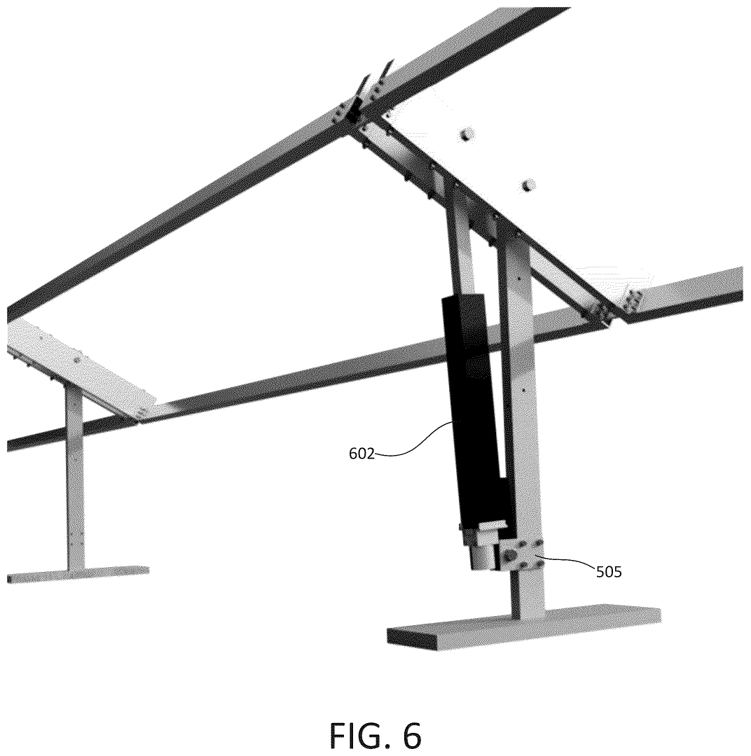

In one or more cases, a strut may be attached to a portion of the support structure and a portion of one or more side rail assemblies. For example, the strut 124 may be coupled to a portion of beam 110 and a portion of side rail assemblies 122b and 122c. For instance, a proximal end of the strut 124 may be coupled to a strut mount assembly (such as strut mount assembly 304 as illustrated in FIG. 3A or strut mount assembly 505 as illustrated in FIG. 5B) of beam 110 (or beam 513) and an opposite end of the strut 124 may be coupled to bearing rails, such as bearing rail 422, of side rail assemblies 122b and 122c. The strut may be configured to resist compression caused by rotation of the racking about the support structures. For example, the strut may be formed of closed-form rectangular steel. In some cases, a number of struts utilized by the system 100 may be based on site design. For example, based on typical wind conditions at the location of the site, the system 100 may include the strut 124 attached to the beam 110 and side rail assemblies 122b and 122c and may not include a strut between beam 108a and side rail assembly 122a and a strut between beam 108b and side rail assembly 122d. In one or more cases, the system 100 may include an actuator (such as actuator 602 as illustrated in FIG. 6) as an alternative to the strut 124. In one or more other cases, the system 100 may include a combination of struts 124 and actuators 602 that are coupled to respective portions of the beams and racking. The actuator 602 may be configured to rotate the racking about a single axis. For example, the actuator 602 may allow the racking to tilt at angles ranging from 20° to 50° to a horizontal axis of the system 100. The actuator 602 may be for example, but not limited to, a linear actuator. The actuator 602 may be for example, but not limited to, a distributed AC linear actuator, which allows maintenance vehicles to freely drive through a solar panel array. The actuator may control up to four sections of racking.

FIG. 3A illustrates an example beam, such as beam 110, coupled with an example shock mount system, such as shock mount system 118 (hereinafter “system 118”). FIG. 3B is an exploded view of the system 118. The system 118 may be configured to constrain the relative motion caused by vibration of the system 100, thereby reducing hole elongation. In one or more cases, the shock mount system 118 may be positioned at one or more critical joints within system 100. The shock mount system 118 may not require lubrication or maintenance. The shock mount systems described herein may reduce or eliminate fatigue on critical joints within the system 100. A critical joint may be, for example, major load-bearing joint within the system 100.

In one or more cases, the system 118 may include two tubular members 302a and 302b coupled to the beam 110, and bearings 306a and 306b positioned within the respective tubular members 302a and 302b. The bearing may be sized to snuggly fit within the tubular member. In one or more cases, the bearings may be formed of a high-density material, such as, but not limited to, ultra-high molecular weight polyethylene (UHMW), high-density polyethylene (HDPE), and other like plastics and polymers.

The tubular members 302a and 302b may be elongated rigid members sized to receive a bearing, such as bearing 306a and bearing 306b. In one or more cases, the members 302a and 302b may be coupled to opposite sides of the beam 110. For example, the members 302a and 302b may be fastened to opposite sides of a web 111 of the beam 110. The bearing, such as bearing 306b, may be inserted into member 302b and fastened therein. For example, one or more through bolts may be inserted through members 302a, 302b, bearings 306a and 306a, and one or more side rail assemblies and may be fastened to the members 302a, 302b, bearings 306a and 306a, and one or more side rail assemblies. As such, the system 118 may be provided at a critical joint at which a beam is coupled to at least one side rail assembly.

It is noted that system 118 includes two bearings 306a and 306b inserted within two respective tubular members 302a and 302b. However, it should be understood that embodiments are contemplated in which a singular tubular member is constructed to straddle each side of the web 111 of the beam 110 and a bearing is inserted within the tubular member. Further, for the cases in which the beam is formed in the shape of a pile, such as beam 513 of FIG. 5B, the shock mount system 118 may be integrated with the beam 513 such that the proximal end of the beam 513 includes a bearing 507.

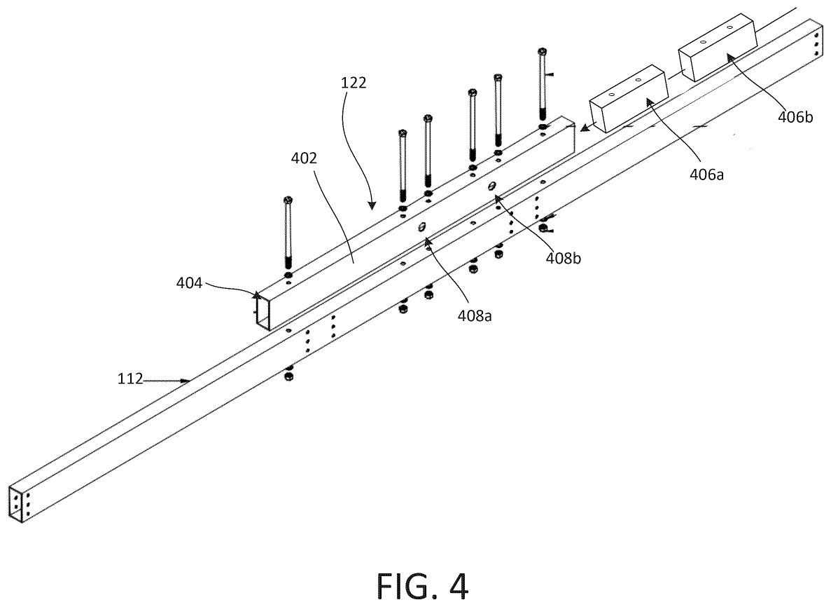

FIG. 4 is an exploded view of an example side rail assembly 122 and shock mount system. In one or more cases, the side rail assembly 122 includes side rail 112 coupled to a bearing rail 402 of the shock mount system. The shock mount system may include the bearing rail 402 and one or more bearings, such as bearings 406a and 406b, inserted within the bearing rail 402. For the cases in which the shock mount system includes one bearing, a length of the bearing may be long enough to extend a distance greater than the distance between thru-holes 408a and 408b, as such, when a fastener is inserted therein, the fastener may be positioned within the bearing. It is noted that bearings 406a and 406b include the same or similar features as bearings 306a and 306b, and a discussion of those features are not repeated. Moreover, similar to that of system 118, the shock mount system of the side rail assembly 122 may be provided at a critical joint at which a beam is coupled to at least one side rail assembly.

FIG. 5A is a perspective top view of the example shock mount systems (e.g., the shock mount systems described with respect to, for example, FIGS. 3A, 3B, and 4) coupled with example racking of FIG. 2. FIG. 5B is a perspective top view of other example shock mount systems coupled with example racking of FIG. 2.

In one or more cases, a shock mount system may be configured to couple to sections of racking, such as racking 104a and 104b, to one another. For example, the side rail assembly 122b of racking 104a may be coupled to the side rail assembly 122c of racking 104b via shock mount system 118. For instance, as illustrated in FIG. 5A, a bolt 509 may be positioned through and fastened to a portion of the side rail assemblies 122b and 122c, members 302a, 302b, and bearings 306a and 306a. In another instance, as illustrated in FIG. 5B, the bolt 509 may be positioned through and fastened to a portion of the side rail assemblies 122b and 122c and a shock mount system 507 integrated at an end portion of beam 513. Further, as illustrated in FIGS. 5A and 5B, the bolt 509 may pass through one or more spacers, such as spacers 504a, positioned between side rail assembly 122c and member 302a, and one or more spacers, such as spacers 504b, positioned in between side rail assembly 122b and member 302b. In one or more cases, another bolt, such as bolt 511, may be positioned through and fastened to another portion of the side rail assemblies 122b and 122c and an end portion of the strut 124. Further, the bolt 511 may pass through one or more spacers, such as spacers 502a, positioned between side rail assembly 122c and the end portion of the strut 124, and one or more spacers, such as spacers 502b, positioned in between side rail assembly 122b and the end portion of the strut 124. The spacers may be formed of a high-density material, such as, but not limited to, UHMW, HDPE, and other like plastics and polymers.

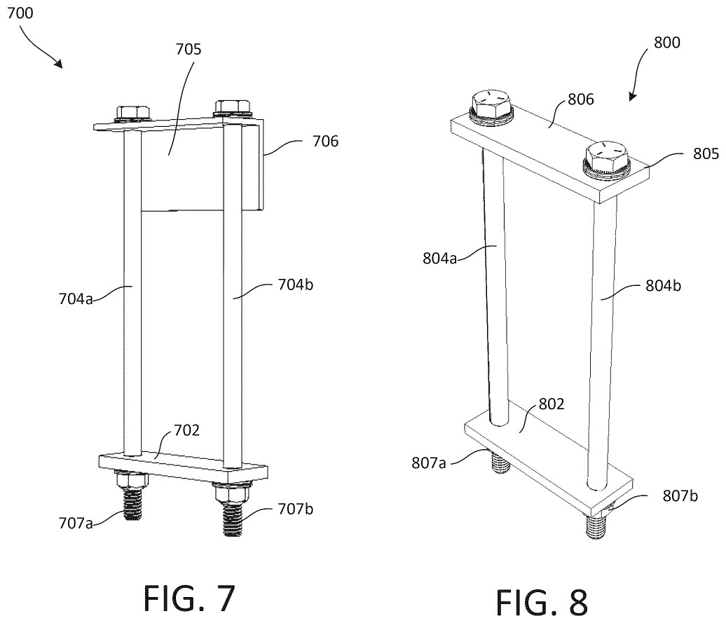

FIG. 7 illustrates an example end dual clamp 700 (hereinafter “clamp 700”). The clamp 700 may include at least one bolt assemblies, such as bolt assemblies 704a and 704b, a clamping plate 702, and an angled clamping plate 706. The angled clamping plate 706 may be sized to interface with an edge of a solar panel. For instance, the length of a mounting surface 705 of the angled clamping plate 706 may correspond to a thickness of the edge of the solar panel. In one or more cases, the angled clamping plate 706 and clamping plate 702 may be positioned on opposite end portions of the bolt assemblies 704a and 704b. The angled clamping plate 706 and clamping plate 702 are configured to translate along the bolt assemblies 704a and 704b, as the fastening members, such as nuts 707a and 707b, are fastened or unfastened to the bolt assemblies 704a and 704b. Although clamp 700 is described as having bolt assemblies 704a and 704b, it should be understood that a U-bolt may be used as well. For example, the two legs of a U-bolt may pass through the corresponding through-holes defined in the angled clamping plate 706, such that the U-shaped portion of the U-bolt resides on the surface of the angled clamping plate 706 that does not interface with a rail, such as rail 114 and 116, and the clamping plate 702 may be positioned on the respective threaded portions of the legs of the U-bolt in a similar fashion as securing the clamping plate 702 to the bolt assemblies 704a and 704b. In another example, the two legs of a U-bolt may pass through the corresponding through-holes defined in the clamping plate 702, such that the U-shaped portion of the U-bolt resides on the surface of the clamping plate 702 that does not interface with a rail, such as rail 114 and 116, and that the angled clamping plate 706 may be positioned on the respective threaded portions of the legs of the U-bolt. In another example, the clamp 700 includes one U-bolt and the angled clamping plate 706, in which the angled clamping plate 706 may be positioned on the respective threaded portions of the legs of the U-bolt. In this configuration, the U-bolt may be positioned to surround a rail from the rear of the racking, thereby allowing the angled clamping plate 706 to interface with an edge of the solar panel. The U-bolt may be, for example, but not limited to, a square U-bolt, a round U-bolt, a semi-square U-bolt, a semi-round U-bolt, a V-bolt, and the like.

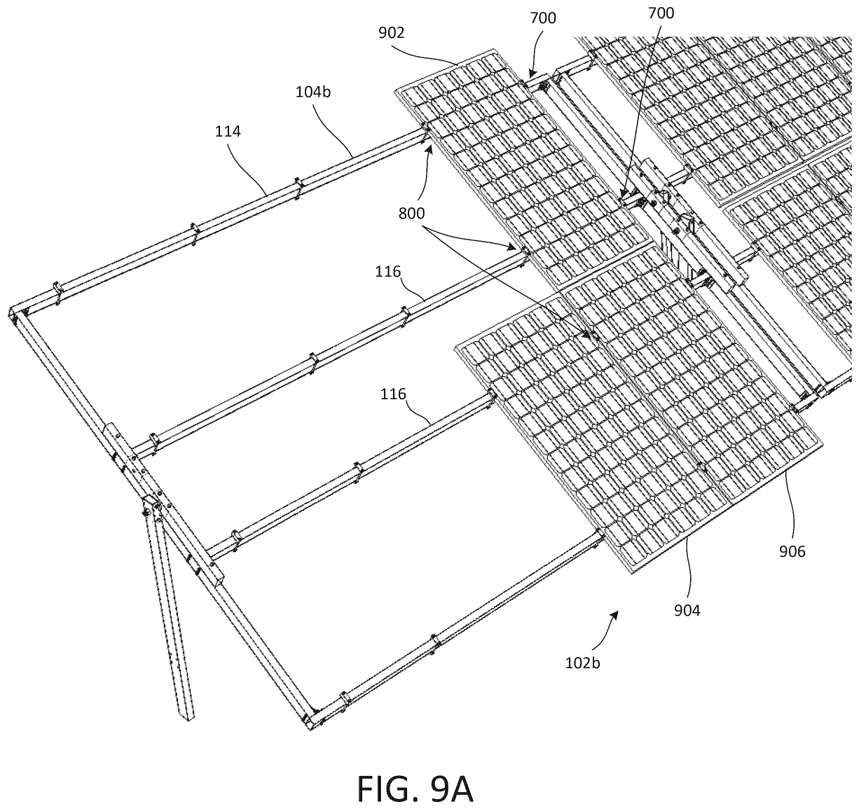

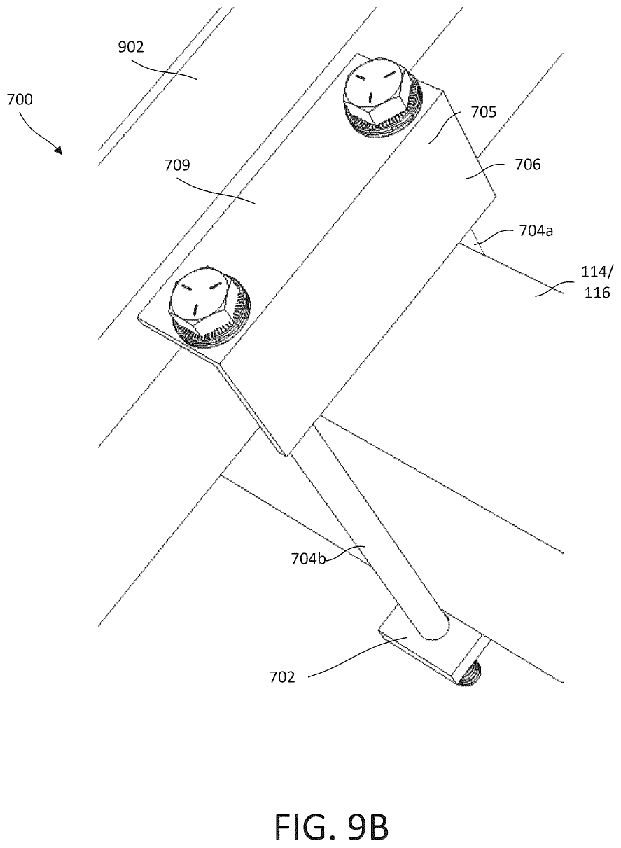

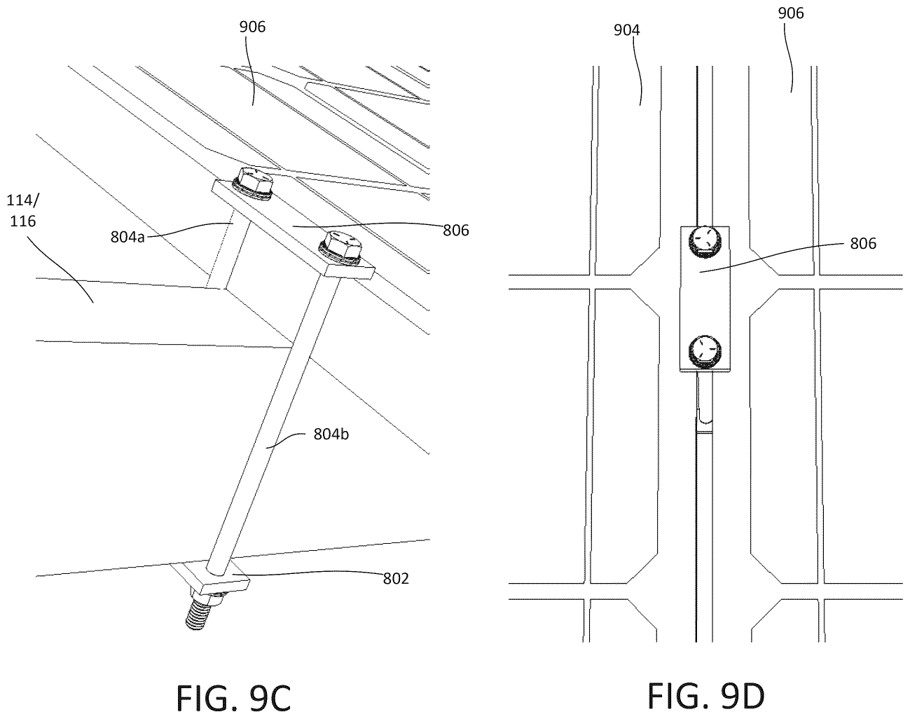

FIG. 8 illustrates an example mid-dual clamp 800 (hereinafter “clamp 800”). The clamp 800 may include at least one bolt assemblies, such as bolt assemblies 804a and 804b, a clamping plate 802, and a top clamping plate 806. The top clamping plate 806 may be sized to interface with surfaces (e.g., top surfaces) of two adjacent solar panels. For instance, a width of a mounting surface 805 of the top clamping plate 806 may correspond to an area large enough to overlap portions of the top surfaces of two adjacent solar panels (e.g., the width of the top clamping plate 806 defined in the horizontal direction as illustrated in FIG. 9D). In one or more cases, the top clamping plate 806 and clamping plate 802 may be positioned on opposite end portions of the bolt assemblies 804a and 804b. The top clamping plate 806 and clamping plate 802 are configured to translate along the bolt assemblies 804a and 804b, as the fastening members, such as nuts 807a and 807b, are fastened or unfastened to the bolt assemblies 804a and 804b. Although clamp 800 is described as having bolt assemblies 804a and 804b, it should be understood that a U-bolt may be used as well. For example, the two legs of a U-bolt may pass through the corresponding through-holes defined in the top clamping plate 806, such that the U-shaped portion of the U-bolt resides on the surface of the top clamping plate 806 that does not interface with a rail, such as rail 114 and 116, and the clamping plate 802 may be positioned on the respective threaded portions of the legs of the U-bolt in a similar fashion as securing the clamping plate 802 to the bolt assemblies 804a and 804b. In another example, the two legs of a U-bolt may pass through the corresponding through-holes defined in the clamping plate 802, such that the U-shaped portion of the U-bolt resides on the surface of the clamping plate 802 that does not interface with a rail, such as rail 114 and 116, and that the top clamping plate 806 may be positioned on the respective threaded portions of the legs of the U-bolt. In another example, the clamp 800 includes one U-bolt and the top clamping plate 806, in which the top clamping plate 806 may be positioned on the respective threaded portions of the legs of the U-bolt. In this configuration, the U-bolt may be positioned to surround a rail from the rear of the racking, thereby allowing the top clamping plate 806 to interface with a surface of the solar panel. The U-bolt may be, for example, but not limited to, a square U-bolt, a round U-bolt, a semi-square U-bolt, a semi-round U-bolt, a V-bolt, and the like.

FIG. 9A illustrates an example installation process in which solar panels, such as a solar panel array 102b, are mounted to an example racking, such as racking 104b, via the example dual clamps 700 and 800. FIG. 9B is a perspective view of the example end dual clamp 700 coupled to a solar panel, such as solar panel 902, and racking 104b. FIG. 9C is a perspective view of the example mid-dual clamp 800 coupled to solar panel 906 and racking 104b. FIG. 9D is a perspective view of the example mid-dual clamp 800 coupled to two solar panels 904 and 906 and example racking 104b.

In one or more cases, to install the solar panel array 102b onto the racking 104b, duals clamps 700 and 800 are positioned around the main rails, such as rail 114, and the mid-rails, such as mid-rails 116. Solar panels, such as panels 902 and 906, positioned at the ends of the array 102b may be positioned on the racking 104b, such that the edge of the solar panel, such as panel 902, is positioned between the top surface 709 and mounting surface 705 of the angled clamping plate 706 and a rail, such as rails 114 or 116. The angled clamping plate 706 and clamping plate 702 are fastened together for each clamp 700, thereby securing the panel 902 to the rail, such as rails 114 or 116.

In one or more cases, the clamps 800 may be positioned over a portion of the panel, such as an edge of the panel 906 that is opposite the edge secured to the clamps 700. For example, the top plate 806 may overlap the opposite edge of the panel 906, as illustrated in FIG. 9C. Another panel, such as panel 904, may be positioned on the racking 104b, such that the edge of the panel 904 may be positioned adjacent the panel 906. The edge of the panel 904 may be positioned in between the top plate 806 of the clamp 800 and the rail, such as rails 114 or 116. The top plate 806 and the plate 802 are fastened together for each clamp 800, thereby securing the panels 904 and 906 to the rail.

In one or more cases, to install the panels on the edge of the array 102b, the end panels, such as panels 902 and 906 are placed on the rails, such as rails 114 and 116. The frames of the panels are positioned under the angled clamping plate 706 of the end dual clamps 700. The end panels 902 and 906 may be aligned and squared with one another and the racking 104b. The bolt assemblies 704a and 704b may be verified as being perpendicular to the respective rails, such as rails 114 and 116. The nuts 707a and 707b of the assemblies 704a and 704b may be torqued to, for example, 15 ft lbs. or to panel manufacture torque recommendations. The mid-dual clamps 800 may be slide along the respective rails until the top clamping plates 806 are positioned over the frames of the panels. Adjacent panels, such as panel 904, are placed on the rails. The frame of the adjacent panel 904 is positioned under the top clamping plates 806 of the mid-dual clamp 800. The adjacent panel 904 may be aligned and squared with the adjacent panels. The bolt assemblies 804a and 804b may be verified as being perpendicular to the respective rails, such as rails 114 and 116. The nuts 807a and 807b of the assemblies 804a and 804b may be torqued to, for example, 15 ft lbs. or to panel manufacture torque recommendations. The installation process repeats until the last panels of the arrays are mounted to the racking.

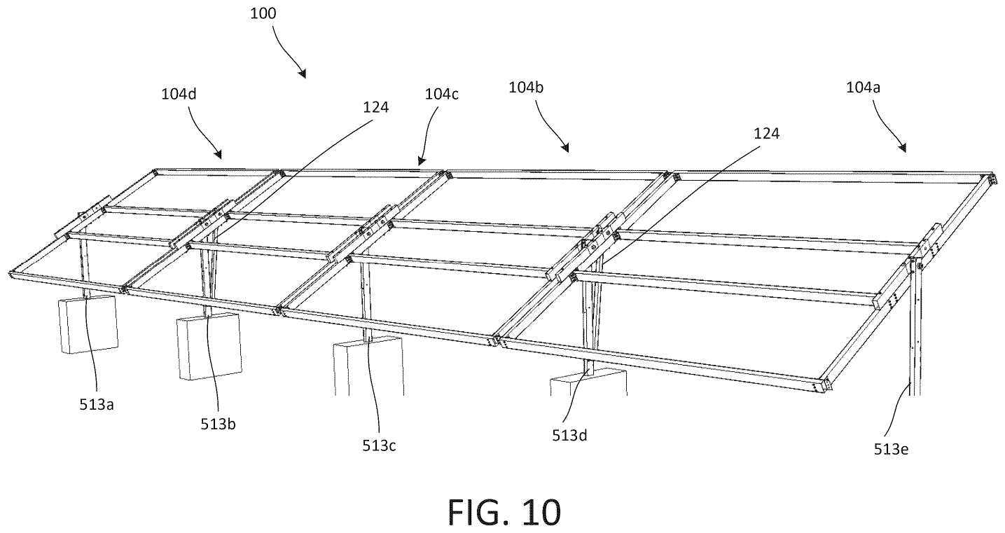

FIG. 10 illustrates a series of racking sections, such as racking 104a, 104b, 104c, and 104d. In one or more cases, struts, such as strut 124 and/or actuator 602 of FIG. 6, may be coupled to one or more beams, such as beam 110 or beams 513. For example, a strut 124 may be coupled to beam 513b and racking 104c and 104d, as described herein. Another strut 124 may be coupled to the beam 513d and racking 104a and 104b, as described herein. The distributed struts along the sections of racking may provide maximum strength and vibration resistance. Moreover, the decoupled nature of the racking sections may minimize the amplitude of oscillations and galloping when the system 100 is subjected to severe weather, such as critical wind events. As such, the system 100 may permit the construction and coupling of any number of racking sections.

A solar racking system, as described herein, comprises: racking disposed between and rotatably coupled to a first support structure and a second support structure; a first support structure comprising an elongated beam and a first shock mount system disposed on a proximal end of the first support structure; a second support structure comprising an elongated beam and a second shock mount system disposed on a proximal end of the second support structure; and racking comprising a first rail and a second rail coupled to a first side rail assembly and a second side rail assembly. The racking is disposed between and rotatably coupled to the first and second support structures via the first shock mount system rotatably coupled with the first side rail assembly and the second shock mount system rotatably coupled with the second side rail assembly.

The solar racking system, as described herein, comprises an array of solar panels mounted to the racking.

The solar racking system, as described herein, comprises the first and second shock mount systems being configured to constrain a relative motion caused by vibration of the solar racking system.

The solar racking system, as described herein, comprises the first shock mount system and second shock mount system each comprising at least one bearing therein. The at least one bearing comprising ultra-high molecular weight polyethylene or high-density polyethylene.

The solar racking system, as described herein, comprises the proximal end of the first support structure comprising a hollow end sized to receive a bearing of the first shock mount system therein.

The solar racking system, as described herein, comprises the first shock mount system comprising a first tubular member sized to snuggly fit a first bearing therein and a second tubular member sized to snuggly fit a second bearing therein; and the first tubular member and second tubular member coupled to opposite sides of the proximal end of the first support structure.

The solar racking system, as described herein, comprises the first side rail assembly comprising a third shock mount system centrally positioned about the first side rail assembly, and a fourth shock mount system centrally positioned about the second side rail assembly.

The solar racking system, as described herein, comprises the third shock mount system being rotatably coupled to the first shock mount system and the fourth shock mount system being rotatably coupled to the second shock mount system.

The solar racking system, as described herein, comprises the first side rail assembly comprising a side rail coupled to a bearing rail of the third shock mount system. The bearing rail includes at least one bearing snuggly fit therein.

The solar racking system, as described herein, comprises a third support structure comprising an elongated beam and a third shock mount system disposed on a proximal end of the third support structure; and second racking comprising a third rail and a fourth rail coupled to a third side rail assembly and a fourth side rail assembly. The second racking is disposed between and rotatably coupled to the second and third support structures via the second shock mount system of the second support structure rotatably coupled with the third side rail assembly and the third shock mount system rotatably coupled with the fourth side rail assembly.

The solar racking system, as described herein, comprises a rotational support member having a first end coupled to a portion of the second support structure and a second end coupled to the second side rail assembly of the racking and the third side rail assembly of the second racking.

The solar racking system, as described herein, comprises the rotational support member comprising a struct or an actuator.

The solar racking system, as described herein, comprises a plurality of end dual clamps and mid-dual clamps configured to fasten an array of solar panels to the racking.

The solar racking system, as described herein, comprises an end dual clamp comprising an angled plate and a planar plate disposed on opposite ends of at one bolt assembly. The angled plate of the end dual clamp is sized to interface with an edge of a solar panel.

The solar racking system, as described herein, comprises a mid-dual clamp comprising a first planar plate and second planar plate disposed on opposite ends of at least one bolt assembly. A width of the first planar plate is sized to interface with top surfaces of two adjacent solar panels.

The solar racking system, as described herein, comprises at least one mid-rail having a first end coupled with the first side rail assembly and a second end coupled with the second side rail assembly.

A solar racking system, as described herein, comprises racking comprising a first rail and a second rail coupled to a first side rail assembly and a second side rail assembly; a first support structure comprising an elongated beam; and a second support structure comprising an elongated beam. The racking is disposed between and rotatably coupled to the first and second support structures via a first shock mount system of the first side rail assembly being rotatably coupled with a proximal end of the first support structure and a second shock mount system of the second side rail assembly being rotatably coupled with a proximal end of the second support structure.

The solar racking system, as described herein, comprises an array of solar panels mounted to the racking.

The solar racking system, as described herein, comprises the first and second shock mount systems being configured to constrain a relative motion caused by vibration of the solar racking system.

The solar racking system, as described herein, comprises the first shock mount system and second shock mount system each comprising at least one bearing therein. The at least one bearing comprises ultra-high molecular weight polyethylene or high-density polyethylene.

The solar racking system, as described herein, comprises the first side rail assembly comprising a side rail coupled to a bearing rail of the first shock mount system. The bearing rail includes the at least one bearing snuggly fit therein.

The solar racking system, as described herein, comprises the first shock mount system of first side rail assembly being centrally positioned about the first side rail assembly, and the second shock mount system of the second side rail assembly being centrally positioned about the second side rail assembly.

The solar racking system, as described herein, comprises the first support structure comprising a third shock mount system disposed on the proximal end of the first support structure, and the second support structure comprising a fourth shock mount system disposed on the proximal end of the second support structure.

The solar racking system, as described herein, comprises the third shock mount system being rotatably coupled to the first shock mount system and the fourth shock mount system being rotatably coupled to the second shock mount system.

The solar racking system, as described herein, comprises the third shock mount system comprising a first tubular member sized to snuggly fit a first bearing therein and a second tubular member sized to snuggly fit a second bearing therein. The first tubular member and second tubular member are coupled to opposite sides of the proximal end of the first support structure.

The solar racking system, as described herein, comprises the proximal end of the first support structure comprising a hollow end sized to receive a bearing of a first shock mount system therein.

The solar racking system, as described herein, comprises a third support structure comprising an elongated beam; and second racking comprising a third rail and a fourth rail coupled to a third side rail assembly and a fourth side rail assembly. The second racking is disposed between and rotatably coupled to the second and third support structures via the second shock mount system of the second side rail assembly rotatably coupled with a third shock mount system of the third side rail assembly.

The solar racking system, as described herein, comprises a rotational support member having a first end coupled to a portion of the second support structure and a second end coupled to the second side rail assembly of the racking and the third side rail assembly of the second racking.

The solar racking system, as described herein, comprises the rotational support member comprising a struct or an actuator.

The solar racking system, as described herein, comprises a plurality of end dual clamps and mid-dual clamps configured to fasten an array of solar panels to the racking.

The solar racking system, as described herein, comprises an end dual clamp comprising at least an angled plate disposed on opposite ends of at least one bolt assembly. The angled plate of the end dual clamp is sized to interface with an edge of a solar panel.

The solar racking system, as described herein, comprises a mid-dual clamp comprising at least a planar plate disposed on opposite ends of at least one bolt assembly. A width of the planar plate is sized to interface with top surfaces of two adjacent solar panels.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A solar racking system comprising:
racking comprising a first rail and a second rail coupled to a first side rail assembly and a second side rail assembly;
a first support structure comprising an elongated beam; and
a second support structure comprising an elongated beam,
wherein the racking is disposed between and rotatably coupled to the first and second support structures via a first shock mount system of the first side rail assembly being rotatably coupled with a proximal end of the first support structure and a second shock mount system of the second side rail assembly being rotatably coupled with a proximal end of the second support structure.

2. The solar racking system of claim 1, further comprising an array of solar panels mounted to the racking.

3. The solar racking system of claim 1, wherein the first and second shock mount systems are configured to constrain a relative motion caused by vibration of the solar racking system.

4. The solar racking system of claim 1, wherein the first shock mount system and second shock mount system each comprise at least one bearing therein, the at least one bearing comprising ultra-high molecular weight polyethylene or high-density polyethylene.

5. The solar racking system of claim 4, wherein the first side rail assembly comprises a side rail coupled to a bearing rail of the first shock mount system, and wherein the bearing rail includes the at least one bearing snuggly fit therein.

6. The solar racking system of claim 1, wherein the first shock mount system of first side rail assembly is centrally positioned about the first side rail assembly, and the second shock mount system of the second side rail assembly is centrally positioned about the second side rail assembly.

7. The solar racking system of claim 1, wherein the first support structure comprises a third shock mount system disposed on the proximal end of the first support structure, and the second support structure comprises a fourth shock mount system disposed on the proximal end of the second support structure.

8. The solar racking system of claim 7, wherein the third shock mount system is rotatably coupled to the first shock mount system and the fourth shock mount system is rotatably coupled to the second shock mount system.

9. The solar racking system of claim 7, wherein:
the third shock mount system comprises a first tubular member sized to snuggly fit a first bearing therein and a second tubular member sized to snuggly fit a second bearing therein; and
the first tubular member and second tubular member coupled to opposite sides of the proximal end of the first support structure.

10. The solar racking system of claim 1, wherein the proximal end of the first support structure comprises a hollow end sized to receive a bearing of a first shock mount system therein.

11. The solar racking system of claim 1, further comprising:
a third support structure comprising an elongated beam; and
second racking comprising a third rail and a fourth rail coupled to a third side rail assembly and a fourth side rail assembly,
wherein the second racking is disposed between and rotatably coupled to the second and third support structures via the second shock mount system of the second side rail assembly rotatably coupled with a third shock mount system of the third side rail assembly.

12. The solar racking system of claim 11, further comprising a rotational support member having a first end coupled to a portion of the second support structure and a second end coupled to the second side rail assembly of the racking and the third side rail assembly of the second racking.

13. The solar racking system of claim 12, wherein the rotational support member comprises a struct or an actuator.

14. The solar racking system of claim 1, further comprising a plurality of end dual clamps and mid-dual clamps configured to fasten an array of solar panels to the racking.

15. The solar racking system of claim 14, wherein an end dual clamp comprises at least an angled plate disposed on opposite ends of at least one bolt assembly, wherein the angled plate of the end dual clamp is sized to interface with an edge of a solar panel, wherein a mid-dual clamp comprises at least a planar plate disposed on opposite ends of at least one bolt assembly, and wherein a width of the planar plate is sized to interface with top surfaces of two adjacent solar panels.
